(19) United States
(12) Patent Application Publication
(10) Pub. No.: US 2006/0227543 A1
(43) Pub. Date: Oct. 12, 2006

(54) Warning device

(75) Inventor: Yen-Shu Tsai, Taipei Hsien (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Li-Yen Lu

(21) Appl. No.: 11/399,323

(22) Filed: Apr. 7, 2006

(30) Foreign Application Priority Data
Apr. 11, 2005 (TW) 094205593

(51) Int. Cl. F21L 4/02

(52) U.S. Cl. 362/184; 362/225; 362/640

(57) ABSTRACT

A warning device is disclosed, including an upper brace comprising an electric device and an output terminal; at least three luminous discharge tubes, which are pervious to light, provided with light sources and interconnected with each one another to form a loop and to establish electric contact. One of the tubes is connected with the output terminal described above to enable the illumination without shielding.

### FIELD OF THE INVENTION

The present invention relates to a warning device, and in particular, to a warning device without dead zones, i.e. a warning device capable of illuminating at different angles.

### BACKGROUND OF THE INVENTION

Warning devices of different kinds are commonly seen in our daily lives; road block and triangular warning frame, for example, are just two of commonly seen warning devices. The technology used in these warning devices are also starkly different, some using reflective materials and others using electronic device of flashing LED (light-emitted diode). Basically, the aim is to attract strong visual attention to send warning signals.

Conventional prior art of warning devices, “Warning Frame,” ROC Pat. No. 424,812, for example, is a taper structure without illuminating. Also, “Warning Frame,” ROC Pat. No. 335,201, is installed by hanging such that illuminating bodies swing with wind. Furthermore, “Warning Frame on Vehicle Roof,” ROC Pat. No. 454,717, discloses a warning structure similar to a windmill rotating in the wind.

LED flashing lights installed in the triangular warning frame somehow do not exhibit the full potential of LED since conventional triangular warning frame has only one warning face.

It is therefore necessary to have a warning device with novel design. With long time experience in designing, production, and marketing warning devices, the applicant proposes the present “Warning Device” after numerous experiments.

### SUMMARY OF THE INVENTION

To further explain the details of a warning device according to the present invention, please first refer to the schematic figures, wherein FIG. 1 is an exploded perspective view of a preferred embodiment of a warning device according to the present invention, FIG. 2 is a perspective assembly view of a warning device according to the present invention, and FIG. 3 is a schematic illustration of another embodiment of a warning device according to the present invention.

### BRIEF DESCRIPTION OF THE DRAWINGS

The present invention can be more fully understood by reference to the following description and accompanying drawings, in which:

FIG. 1 is an exploded perspective view of a preferred embodiment of a warning device according to the present invention;

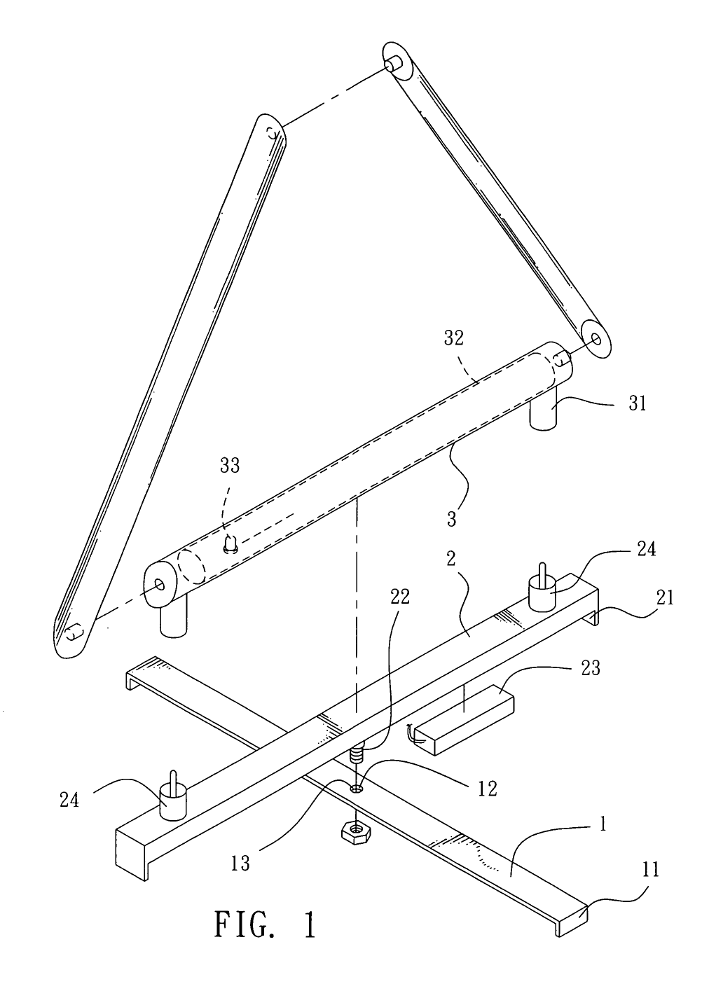

FIG. 2 is a perspective assembly view of a warning device according to the present invention; and

FIG. 3 is a schematic illustration of another embodiment of a warning device according to the present invention.

### DETAILED DESCRIPTION OF THE INVENTION

The warning device, as shown in the figures, comprises a lower brace 1, an upper brace 2, and three luminous discharge tubes 3. The lower brace 1 is a long bar with a lower brace leg 11 extending downward on the both ends of the lower brace 1, respectively, and in the middle of the lower brace 1 is provided with a bottom hole 12 of which inner wall is provided with female thread 13. To achieve better a better stability, the lower brace 1 is made of material with higher density, for example but not limited to, metal.

The upper brace 2, similar to the lower brace 1, is provided with an upper brace leg 21 on the both ends of the upper brace 2, respectively, and in the middle of the upper brace 2 is provided a connector 22 for locating with the bottom hole 12. The connector 22 may be a hole with threads and further engaged with a screw, may be a screw extending downward and further engaged with the bottom hole 12 by a nut, or may simply be a rod passing through the bottom 12, which are a conventional prior art and will not discussed further.

To facilitate the supply and control of power, an electric device 23 provided on the bottom of the upper brace 2, comprises at least an electric circuit, a battery, and a controlling switch, which is a conventional prior art and will not discussed further. Furthermore, the both ends of the upper brace 2 are provided with a sleeve 24, respectively, extending upward. One of the sleeves 24 is connected and electricly contacted with a protruding rod 31 provided on a luminous discharge tube 3 described later.

The luminous discharge tubes 3 are tubes of, preferably but not limited to, circular cross section, comprising at least three tubes. Both ends of the luminous discharge tubes 3 are provided with connectors such that the luminous discharge tubes 3 can be connected together to form a loop. In one embodiment of the present invention, the three luminous discharge tubes 3 form a triangular shape. The connection between the luminous discharge tubes 3 is a secured connection, which is also easy to disconnect, and the connectors for the connection between the luminous discharge tubes 3 are electric terminals. Furthermore, the lower and horizontal luminous discharge tube 3 is provided with a protruding rod 31 on both ends, respectively. One of the protruding rods 31 is connected and electricly contacted with the sleeve 24 and easily detachably connected with the upper brace 2 described earlier. For the aspect of easy disconnection, a fastener may be provided for securing the connection, which is a conventional prior art and will not discussed further.

The luminous discharge tube 3 is preferably made of material pervious to light. The color of the luminous discharge tube 3 is, for example but not limited to, red. To enhance the warning effect, the inner wall of the luminous discharge tube 3 may be deposited with reflective cloth 32. To illuminate light, a light source 33, LED for example, may be provided to achieve a flashing effect. Consequently, the electric device 23 may be provided with a flashing light circuit, which is a conventional prior art and will not be discussed further.

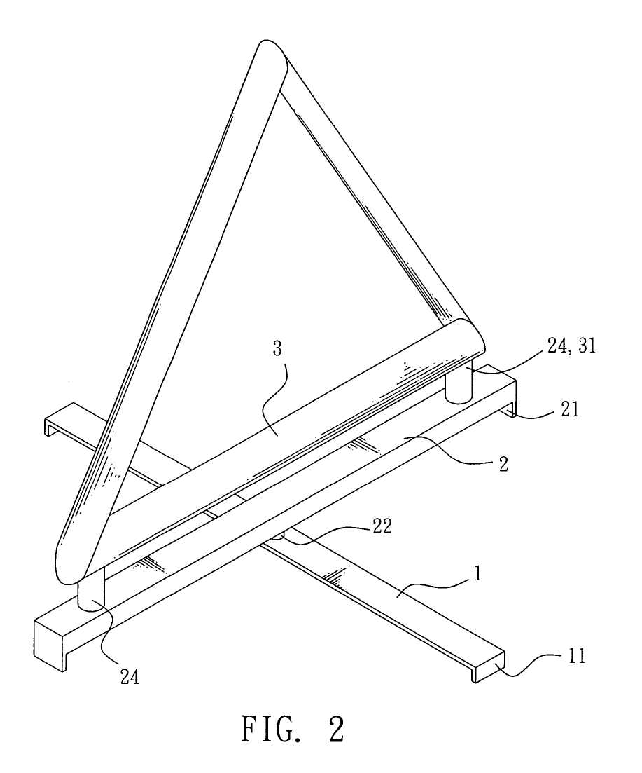

Referring to FIG. 2, when the warning device being assembled, the luminous discharge tubes 3 are connected together and electricly contacted with each other. The lower brace 1 is also connected with the upper brace 2, which is further connected with the horizontal luminous discharge tube 3 to form a condition of being able to be placed at proper location. When the power is supplied, the luminous discharge tubes 3 can emit light.

The luminous discharge tubes 3 are tubular shapes without been shielded. Consequently, the light emitted form the luminous discharge tubes 3 can be seen at different angles, which cannot be achieved in conventional prior arts and can be considered as an innovation.

When the warning device according to the present invention is implemented, the upper brace 2 and the lower brace 1 may be replaced with a single upper brace 2, which is made of heavier material and can support the whole structure in the upright condition.

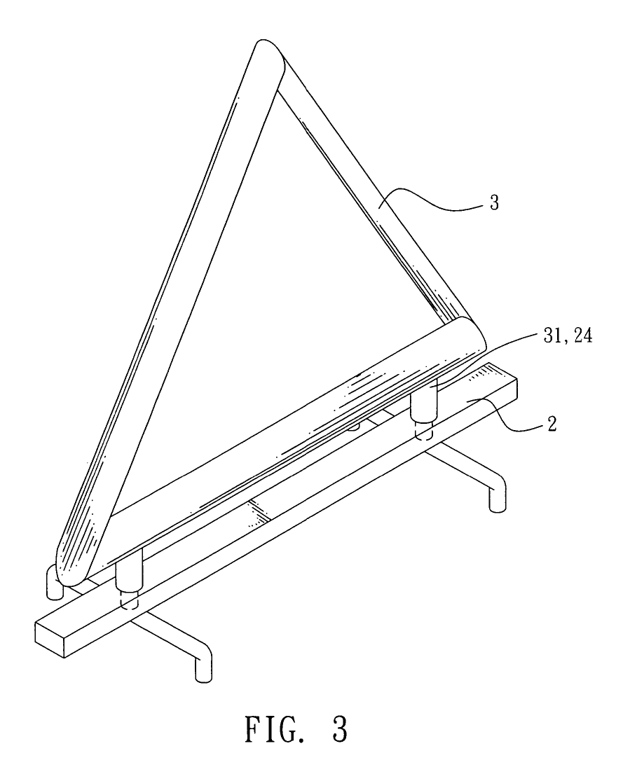

Referring to FIG. 3, another embodiment of the warning device according to the present invention is provided with two lower braces 1, which are disposed on the both sides of the upper brace 2, respectively. The lower braces 1 can be retracted back for storing or extended out for forming a frame by rotating.

While the invention has been described with reference to the a preferred embodiment thereof, it is to be understood that modifications or variations may be easily made without departing from the spirit of this invention, which is defined by the appended claims.

What is claimed is:

1. A warning device, comprising:
an upper brace comprising an electric device and an output terminal; and
at least three luminous discharge tubes, which are pervious to light, provided with light sources and interconnected with each one another to form a loop and to establish electric contact, wherein one of the tubes is connected with the output terminal described above to enable the illumination of luminous discharge tubes without been shielded.

2. The warning device as defined in claim 1, wherein on the bottom of the upper brace is further provided with a lower brace which is rotatingly connected with the upper brace, and the upper brace and the lower brace are provided with a brace leg extending downward on their both ends, respectively.

3. The warning device as defined in claim 1, wherein on the bottom of the both sides of the upper brace is further provided with a lower brace, respectively, which is rotatingly connected with the upper brace, and both ends of the lower braces are provided with a brace leg extending downward, respectively.

4. The warning device as defined in claim 1, wherein the luminous discharge tubes are color and pervious to light.

5. The warning device as defined in claim 1, wherein the luminous discharge tubes are colorless and deposited with reflective cloth in their inner walls.

6. The warning device as defined in claim 1, wherein the light source is LED.

7. The warning device as defined in claim 1, wherein the electric device is a flashing light circuit.

8. The warning device as defined in claim 1, wherein the horizontal luminous discharge tube is provided with a protruding rod on both ends, respectively, and one of the protruding rods is provided with an electric terminal; the both ends of the upper brace are provided with a corresponding sleeve, respectively, extending upward and the sleeve corresponding to the protruding rob with an electric terminal is further provided with electric output to achieve both locating engagement and electric contact.

9. The warning device as defined in claim 1, wherein the electric device is provided with a battery and a switch.

10. The warning device as defined in claim 1, wherein the connection of the upper brace and lower brace is achieved with a screw hole and a screw.
